(19) United States
(12) Patent Application Publication
(10) Pub. No.: US 2010/0041330 A1
(43) Pub. Date: Feb. 18, 2010

(54) SYNCHRONIZED PLAYING OF SONGS BY A PLURALITY OF WIRELESS MOBILE TERMINALS

(75) Inventor: Peter Johannes Elg, Helsingborg (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/190,681

(22) Filed: Aug. 13, 2008

(51) Int. Cl. H04H 40/00

(52) U.S. Cl. 455/3.06

(57) ABSTRACT

A mobile terminal can select among a plurality of subcomponents of a song that are to be played from the terminal in response to communications with another terminal which may concurrently play a different subcomponent of the same song. The mobile terminal can alternatively or additionally identify a song that is being played by another terminal, identify a current playback location within a song data file for the identified song, and begin playing the identified song at the identified location in the song data file.

### FIELD OF THE INVENTION

The present invention relates to the field of wireless communications in general and, more particularly, to playing songs through wireless communication terminals.

### BACKGROUND OF THE INVENTION

Wireless mobile terminals (e.g., cellular telephones) are widely used to store and playback song files. The relative diminutive size of their speakers limits their sound level and fidelity. Users may transfer a song file from one terminal to other terminals via a wireless network (e.g., Bluetooth network) and may download a common song file from an on-line server. Users may thereby play the same song from a plurality of proximately located terminals to increase the resulting sound level of the song.

### SUMMARY OF THE INVENTION

In accordance with some embodiments, a wireless mobile terminal includes a radio frequency (RF) transceiver, a speaker, and a controller. The RF transceiver is configured to communicate via a wireless communication network with other terminals. The controller is configured to select among a plurality of subcomponents of a song to be played from the terminal in response to communications with at least one other terminal, and to play the selected song subcomponent through the speaker.

In another further embodiment, the controller is further configured to assign at least one subcomponent of the song to the other terminal and to transmit a subcomponent assignment request to the other terminal that requests that the other terminal play the identified at least one subcomponent therefrom.

In a further embodiment, the terminal further includes a movement sensor that generates a movement signal responsive to movement of the terminal, and the controller is further configured to shuffle the assignment of subcomponents to itself and the other terminal among the song subcomponents in response to the movement signal.

In a further embodiment, the controller is further configured to select among a plurality of instrument tracks contributing to the song to choose at least one instrument track that is to be played in response to communications with the at least one other terminal indicating that the other terminal will play at least one different instrument track of the song.

In another further embodiment, the terminal further includes a microphone that generates a microphone signal. The controller is further configured to compare a spectral pattern in the microphone signal of the song played by the other terminal to an expected spectral pattern defined by song data and to select among the instrument tracks to play a subcomponent of the song that is indicated by the compared difference to be absent in the song played by the other terminal.

In another further embodiment, the controller is further configured to control a filter that filters the song played from the terminal to pass-through a frequency range corresponding to the selected song subcomponent while attenuating other frequencies of the song.

In another further embodiment, the controller is further configured to compare a spectral pattern in the microphone signal of the song played by the other terminal to an expected spectral pattern defined by song data and to tune the filter responsive to the compared difference to compensate for spatial attenuation of sound from the other terminal.

In another further embodiment, the controller is further configured to identify a location within the song of a match between a pattern of the song played by the other terminal and a known pattern of the song and to adjust its playback time within the song based on the identified location to compensate for sound delay due to spatial separation from the other terminal.

In another further embodiment, the terminal further includes a movement sensor that generates a movement signal responsive to movement of the terminal. The controller is further configured to vary pitch of the song subcomponent that is played from the terminal in response variation of the movement signal.

In another further embodiment, the controller is further configured to communicate with the other terminal to synchronize song playback clocks and to define a playback start time in the respective terminals.

In another further embodiment, the controller is configured to synchronize the song playback clock in response to occurrence of a repetitively occurring signal of a communication network through which the terminals communicate.

In another further embodiment, the transceiver communicates with the other terminal through frames of a Bluetooth wireless network and/or through WLAN packets, and the controller is configured to transmit a command to the other terminal that requests the other terminal to begin playing the song after occurrence of a defined frame of the Bluetooth wireless network and/or occurrence of a defined WLAN communication packet.

In some other embodiments, a wireless mobile terminal includes a RF transceiver, a speaker, microphone, and a controller. The controller is configured to identify a song present in a microphone signal from the microphone, to identify a current playback location within a song data file for the identified song, and to play the identified song starting at a location defined relative to the identified location in the song data file.

In a further embodiment, the controller is further configured to record a portion of a song in the microphone signal, to transmit the recorded portion of the song as a message via the RF transceiver to an identification server along with a request for identification of the song and identification of a song file server that can supply the identified song, and to respond to a responsive message received from the identification server by establishing a communication connection via the RF transceiver to the identified song file server and requesting transmission therefrom of the song data file.

In a further embodiment, the controller is further configured to respond to the message from the identification server containing an Internet address of the song file server from which the identified song can be downloaded by the terminal by establishing a communication connection to the identified Internet address of the song file server and downloading therefrom the song data file.

In a further embodiment, the controller is further configured to identify the current playback location within the song data file received from the identified song file server in response to a match between a pattern of the song currently in the microphone signal and a pattern of the song in the song data file, and to initiate playing of the identified song starting at a location defined relative to the identified location in the song data file.

In a further embodiment, the controller is further configured to select among a plurality of subcomponents of the song in response to communications with at least one other terminal indicating that the other terminal will play at least one different subcomponent of the song, and is configured to play the selected song subcomponent through the speaker.

In a further embodiment, the controller is further configured to control a filter that filters the song played from the terminal to pass-through a frequency range corresponding to the selected song subcomponent while attenuating other frequencies of the song.

In a further embodiment, the controller is further configured to compare a spectral pattern of the song in the microphone signal to an expected spectral pattern defined by song data and to tune the filter responsive to the compared difference to compensate for spatial attenuation of sound from the other terminal.

In a further embodiment, the controller is further configured to compare a spectral pattern of the song in the microphone signal to an expected spectral pattern defined by song data and to select among the instrument tracks to play a subcomponent of the song that is indicated by the compared difference to be absent in the song played by the other terminal.

In a further embodiment, the terminal further includes a movement sensor that generates a movement signal. The controller is further configured to vary pitch of the song subcomponent that is played from the terminal in response variation of the movement signal.

In a further embodiment, the controller is further configured to communicate with another terminal via the RF transceiver to synchronize song playback clocks in the respective terminals, and to tune a current playback location of the song from the song data file in response to the synchronized song playback clock.

Other apparatus, systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a system diagram of a communication system that includes a plurality of wireless mobile communication terminals that can cooperatively play different subcomponents of a song and/or can join-in in playing the same song as another terminal by listening to the song, identifying the song, and identifying a playback location within a corresponding song data file in accordance with some embodiments of the present invention;

FIG. 2 is a block diagram of at least one of the terminals of FIG. 1 in accordance with some embodiments of the present invention;

FIG. 3 is a flowchart showing exemplary operations and methods of at least one of the terminals of FIG. 1 for cooperatively playing a selected subcomponent of a song synchronized with the other terminals in accordance with some embodiments of the invention; and

FIG. 4 is a flowchart showing exemplary operations and methods of at least one of the terminals of FIG. 1 for identifying a song that is playing external thereto and joining-in in playing the song in accordance with some embodiments of the invention.

### DETAILED DESCRIPTION OF EMBODIMENTS OF THE INVENTION

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the art.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/” includes any and all combinations of one or more of the associated listed items. In the drawings, the size and relative sizes of regions may be exaggerated for clarity. Like numbers refer to like elements throughout.

Some embodiments may be embodied in hardware and/or in software (including firmware, resident software, micro-code, etc.). Consequently, as used herein, the term “signal” may take the form of a continuous waveform and/or discrete value(s), such as digital value(s) in a memory or register. Furthermore, various embodiments may take the form of a computer program product on a computer-usable or computer-readable storage medium having computer-usable or computer-readable program code embodied in the medium for use by or in connection with an instruction execution system. Accordingly, as used herein, the terms “circuit” and “controller” may take the form of digital circuitry, such as computer-readable program code executed by an instruction processing device(s) (e.g., general purpose microprocessor and/or digital signal processor), and/or analog circuitry.

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

As used herein, a “wireless mobile terminal” or, abbreviated, “terminal” includes, but is not limited to, any electronic device that is configured to transmit/receive communication signals via a long range wireless interface such as, for example, a cellular interface, via a short range wireless interface such as, for example, a Bluetooth wireless interface, a wireless local area network (WLAN) interface such as IEEE 801.11a-g, and/or via another radio frequency (RF) interface. Example terminals include, but are not limited to, cellular phones, PDAs, and mobile computers that are configured to communicate with other communication devices via a cellular communication network, a Bluetooth communication network, WLAN communication network, and/or another RF communication network.

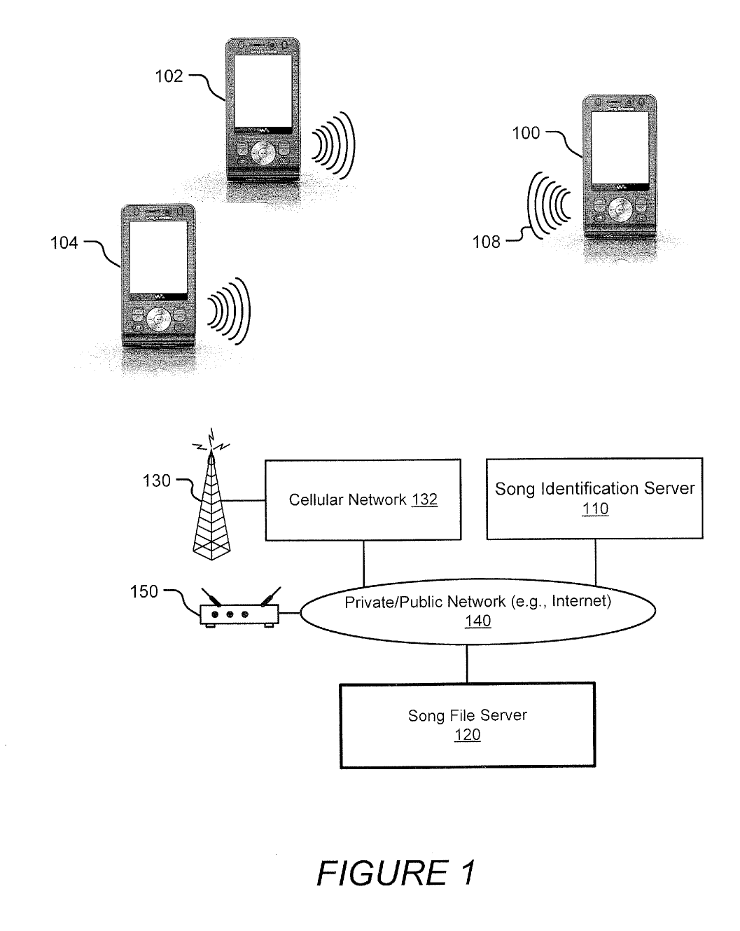

Various embodiments of the present invention are directed to enabling a group of persons to play the same song or subcomponents thereof from their wireless mobile terminals in a coordinated maimer so as to, for example, increased the volume and/or perceived fidelity of the combined sound. FIG. 1 is a system diagram of a communication system that includes a plurality of wireless mobile communication terminals 100, 102, and 104 that are configured to play the same song in a coordinated manner in accordance with some embodiments of the present invention.

The terminals 100, 102, and 104 can be configured to cooperatively play different subcomponents of a same song at a same time and in a synchronized manner to form a musical concert. In some embodiments, the terminal 100 can assign different subcomponents of the same song to itself and to the other terminals 102 and 104, and can communicate the assigned subcomponents to those terminals to cause each of the terminals 100, 102, and 104 to play at least some different subcomponents of the same song at the same time. Thus, terminal 100 can play a vocal portion of a song while terminal 102 plays a percussion portion and terminal 104 plays guitar and synthesizer portions of the song.

Alternatively or additionally, one or more of the terminals 100, 102, and 104 can be configured to join-in to play the same song that is presently being played by another one of the terminals by listening to the song, identifying the song, and identifying a playback location within a corresponding song data file. Alternatively or additionally, the terminals 100, 102, and 104 may wireless communicate with each other identify a song that is being played, to determine a current playback time of the song, and/or to synchronize internal song playback clocks. The terminal(s) can then begin playing the same song as the other terminal from the same or similar location within the song that is continuing to be played by the other terminal.

Thus, for example, in response to a user initiated action, the terminals 102 and 104 can identify a song that is being played by terminal 100, identify a present playback location within a correspondent song data file, and synchronously join-in playing the same song without necessitating further interaction from respective users of those terminals. Such coordinated and cooperative planning of the same song may thereby increase the volume and/or perceived fidelity of the combined sound for the song, and thereby partially overcome the individual sound level and fidelity limitations of the individual terminals. Moreover, this operational functionality may provide desirable social interaction of users that increases the demand for such terminals.

With further reference to FIG. 1, the terminals 100, 102, and 104 may be internally configured to identify a song that is being played by another device, and/or the song identification functionality may reside in a remote networked server. For example, the terminals 100, 102, and 104 may be configured to identify a song that is being played by another terminal when they contain that song within an internal repository of songs, and may be configured to otherwise communicate with a song identification server 110 to identify the song and to obtain the song from a song file server 120.

As will be explained in further detail below, the song identification server 110 may not contain a data file for the identified song, but may be configured to identify a song file server 120 that can supply a data file for the identified song to the terminal (e.g. as a downloadable data file and/or as streaming audio data). Accordingly, a terminal working with the identification server 100 can automatically identify a sensed song and can then identify and connect to a song file server 120 to receive the identified song therefrom. Moreover, a terminal may identify and begin playing the song from a present location where another terminal is playing the song to thereby synchronously join-in playing the song.

These and other exemplary operations and embodiments of the wireless terminals 100, 102, and 104, the identification server 110, and the song file server 120 are further described below with regard to FIGS. 1-4.

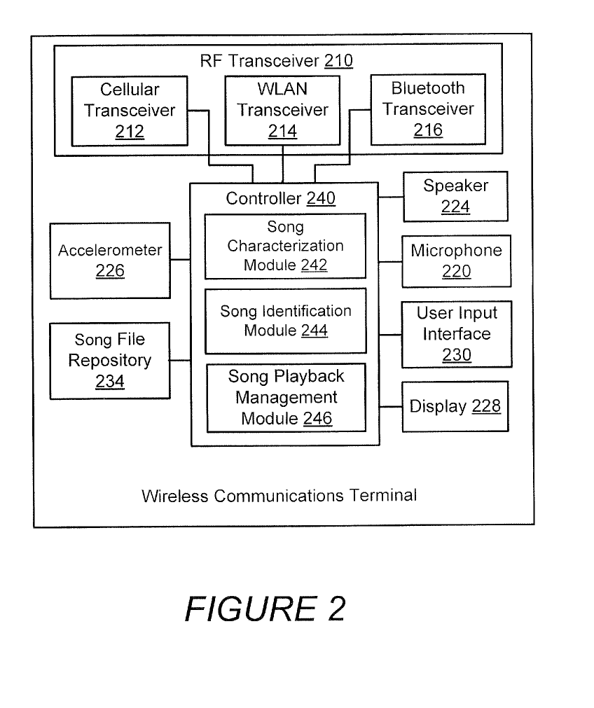

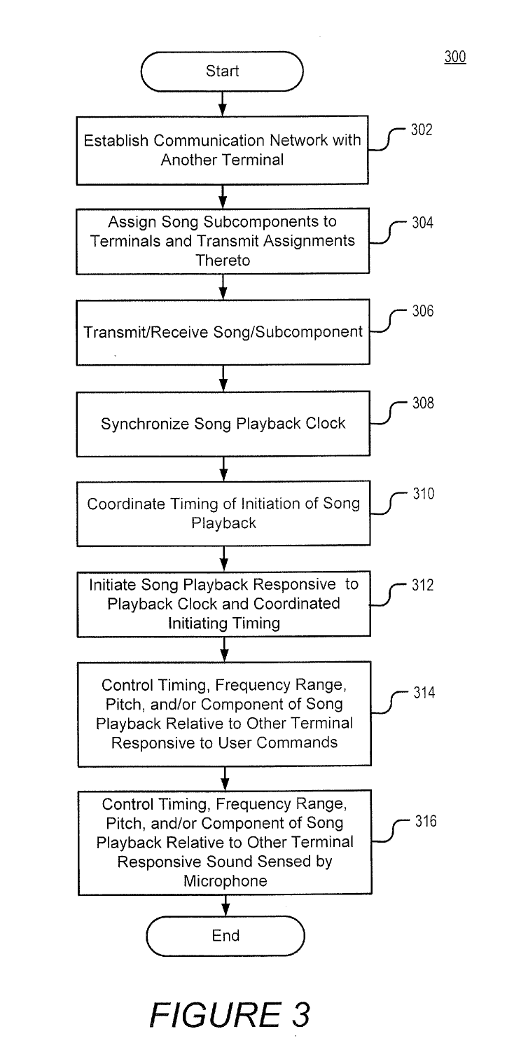

FIG. 2 is a block diagram of at least one of the terminals 100, 102, and 104 of FIG. 1 according to some embodiments. FIG. 3 is a flowchart showing exemplary operations 300 and methods of at least one of the terminals 100, 102, and 104 of FIG. 1 according to some embodiments.

Referring to FIG. 2, an exemplary terminal includes a wireless RF transceiver 210, a microphone 220, a speaker 224, a single/multi-axis accelerometer module 226 (or another senses that detects movement of the terminal), a display 228, a user input interface 230 (e.g., keypad/keyboard/touch interface/user selectable buttons), a song data file repository 234 (e.g., internal non-volatile memory and/or removable non-volatile memory module), and a controller 240. The controller 240 can include a song characterization module 242, a song identification module 244, and a song playback management module 246.

With additional reference to FIG. 3, its assumed for purposes of explanation only that terminals 100, 102, and 104 are each configured as shown in FIG. 2, and that terminal 100 functions as a master while the other terminals 102 and 104 function as slaves according to the illustrated operations 300 to allocate different subcomponents of a song to the different terminals 100, 102, and 104 for concurrent playing in a synchronized maimer. It is to be understood that the terms “master” and “slave” as used herein refer to one terminal that is controlling another terminal regarding the selection of music and/or timing of music that is played therefrom, and is not referring to Bluetooth link master and slave roles.

Initially, the controller 240 of terminal 100 establishes (block 302) a communication network with terminals 102 and 104 via one or more transceivers of the RF transceiver 210. In the exemplary embodiment of FIG. 2, the RF transceiver 210 can include a cellular transceiver 212, a WLAN transceiver 214 (e.g., compliant with one or more of the IEEE 801.11a-g standards), and/or a Bluetooth transceiver 216. The cellular transceiver 212 can be configured to communicate using one or more cellular communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS). Accordingly, the terminal 100 can communicate with other terminals 102 and 104 and/or with the identification server 110 and the song data server 120 via a WLAN, a Bluetooth network, and/or a cellular network.

The song playback management module 246 of the controller 240 may assign (block 304) one or more subcomponents of a song to itself and assign the same or different subcomponent of the same song to the other terminals 102 and 104. The module 246 can communicate (block 304) a request to those terminals that they play the assigned subcomponents. Thus, terminal 100 can play an assigned vocal portion of a song while terminal 102 plays an assigned percussion portion and terminal 104 plays assigned guitar and synthesizer portions of the song.

The module 246 may play an assigned subcomponent by selecting among a plurality of separate tracks of subcomponent data for a song (e.g., select among MIDI tracks for a song). Alternatively or additionally, the module 246 may control an internal/external filter (e.g., one or more bandpass filters), which filters the audio signal for the song that is output through the speaker 224, to pass through one or more frequency ranges corresponding to the assigned subcomponent while attenuating other audio frequencies. The terminals 100, 102, and 104 may therefore play a bass range, mid-range, and high-range frequencies, respectively, in response to the subcomponent assignments.

The assignment of subcomponents to be played by each of the terminals 100, 102, and 104 can be defined by users thereof and/or can be defined automatically without user intervention in response to defined characteristics of each of the terminals (e.g., known number of speakers, speaker size, maximum speaker power capacity, and/or other known audio characteristics of each of the terminals). For example, the module 246 may query terminals 102 and 104 to determine their audio characteristics and then assign song subcomponents to each of the terminals 100, 102, and 104. A terminal having more speakers and/or greater speaker power capacity may be assigned more song subcomponents and/or lower frequency components of a song, while another terminal having fewer speakers and/or less speaker power capacity may be assigned fewer song subcomponents and/or higher frequency components of a song.

The module 246 may shuffle the assignment of the subcomponents among the terminals 100, 102, and 104 in response to at least a threshold level of movement sensed by the accelerometer 226, and can communicate the newly shuffled assignments to the other terminals 102 and 104 to dynamically change which terminals are playing which song subcomponents. Accordingly, while a song is being collectively played by the terminals 100, 102, and 104, a user may shake the terminal 100 to cause them to play different subcomponents of the song. Thus, by shaking a terminal, a user can cause a terminal that was playing a percussion component to begin playing a vocal portion, and cause another terminal that was playing the vocal portion to being playing the percussion component while the song continues to play with perhaps a brief interruption during the reassignment.

The module 246 may transmit (block 306) data for an entire song or assigned subcomponent thereof to the other terminals 102 and 104 or may receive such data therefrom. Accordingly, it is not necessary for all of the terminals 100, 102, and 104 to contain the entire song or assignable subcomponents thereof in order to be capable of joining in concert in the playing of a song.

The perceived fidelity of the combined musical output of the terminals may be improved by each of the terminals 100, 102, and 104 being configured to start playing their assigned song subcomponents in a synchronous manner. The controller 240 may communicate with the other terminals 102 and 104 to synchronize (block 308) song playback clocks and to coordinate a playback start time in the respective terminals (block 310). The song playback clocks may be synchronized relative to occurrence of a repetitively occurring signal of the communication network which interconnects the terminals 100, 102, and 104. More particularly, when the terminals 100, 102, and 104 communicate with each other through communication frames controlled by the Bluetooth transceiver 216, the controller 240 can transmit a command to the other terminals that requests the other terminals to begin playing the song after occurrence of a defined frame access code for one of the frames. The song playback management module 246 can then initiate playing of the song in response the playback start time occurring relative to the coordinated song playback clock (block 312).

While the terminals 100, 102, and 104 are cooperatively playing a song, a user can command (block 314) one or more of the terminals to vary the playback timing relative to the other terminals so as to provide audio delay affects therebetween. For example, a time delay between when each of the terminals 100, 102, and 104 plays a particular portion of a song can be varied in response to a user command so as to provide, for example, more or less perceived spatial separation between the terminals 100, 102, and 104 and/or other audio effects (e.g., echo-effects). A user may similarly adjust or change what subcomponent of the song is being played by a particular terminal (block 314), such as by varying a frequency range of the song that is output from the terminal, and/or by varying the pitch of the song. A user may provide these commands through the user input interface 230 and/or as a vibrational input by shaking the terminal (which is sensed by the accelerometer 226) to cause the song playback management module 246 to change the song subcomponent, frequency range, and/or pitch of the song being played. A user may thereby shake a terminal to, for example, increase/decrease and/or corresponding dynamically modulate the pitch of a guitar/drum/vocal portion of a song.

Moreover, while the terminals 100, 102, and 104 are cooperatively playing a song, the module 246 may listen via the microphone 220 to the combined sound that is generated by the terminals, and may tune (block 316) its playback timing relative to the other terminals to, for example, become more time aligned with the other terminals playing the song and/or to otherwise vary the timing offset to provide defined spatial separation effects (e.g., user defined offset values) relative to the other terminals. The module 246 may determine its relative playback timing by identifying a location within the song data that matches a pattern of the sensed song, and may adjust its playback time within the song based on the identified location to compensate for sound delay due to spatial separation from the other terminal.

The module 246 may additionally or alternatively respond to sound from other terminals present in the microphone signal by controlling the pitch of the sound that it outputs and/or by varying the song subcomponent that it plays (block 316). For example, the module 246 may compare a spectral pattern in the microphone signal of the song played by the other terminal to an expected spectral pattern defined by song data, and tune the pass-through frequency of an audio output filter in response to the compared difference to compensate for spatial attenuation of sound from the other terminals. The module 246 may briefly stop playing music while it listens to the sound from the other terminals.

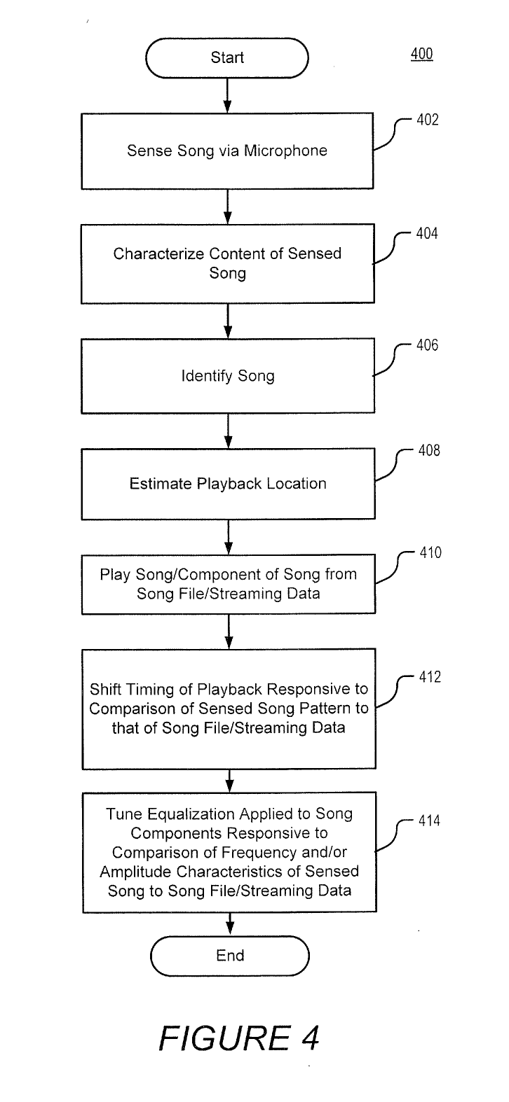

In some other embodiments, the terminals 100, 102, and 104 can be configured to join-in to concurrent play the same song in synch with what is presently being played by another one of the terminals. FIG. 4 is a flowchart showing exemplary operations and methods of at least one of the terminals of FIG. 1 for identifying a song that is playing external thereto and joining-in in playing the song.

Referring to FIG. 4, the song characterization module 242 of the controller 240 is configured to listen to and characterize the song played by another terminal via the microphone signal from the microphone 220. The song identification module 244 is configured to identify the song and to identify a playback location within a corresponding song data file. The song playback management module 246 can then begin playing the same song as the other terminal from the same or similar location within the song as the other terminal.

The song characterization module 242 can sense (block 402) within the microphone signal a song that is being played by another terminal. The song characterization module 242 may characterize the sensed song by recording (block 404) a portion of the song into a memory. The song identification module 244 may attempt to internally identify (block 406) the song by comparing a pattern of the recorded song to patterns defined by song data files within the terminal. When no match is found, the song identification module 244 may transmit to the song identification server 110 a message containing the recorded song and a request for identification of the song and/or for identification of a song file server 120 from which a song data file for the song can be obtained.

The module 244 may communicate the message to the identification server 110 through the cellular transceiver 212, a cellular base station transceiver 130, and an associated cellular network 132 (e.g., mobile switching office) and a private/public network (e.g., Internet) 140. Alternatively or additionally, the module 244 may communicate the message to the identification server 110 through the WLAN transceiver 214, a Wireless Local Area Network (WLAN)/Bluetooth router 150, and the private/public network 140.

The identification server 110 can identify (block 406) the song by, for example, comparing a pattern of the recorded song in the message to known patterns, and can further identify the song file server 120 (e.g., such as via an Internet address or other resource identifier) as being available to transmit the song data file to the terminal 100. A response message can be communicated from the identification server 110 to the terminal through the private/public network 140 and the cellular network 132 and cellular base station transceiver 130, and/or through the private/public network 140 and the WLAN router 150 to the terminal.

The song playback management module 246 can respond to the received message by establishing a communication connection to the song file server 120, such as through the wireless communication link with the cellular base station transceiver 130 and/or with the WLAN router 150. The module 246 can send a message to the song file server 120 requesting transmission of the identified song therefrom. In some embodiments, the song file server 120 can download the song data file and/or stream the identified song data to the terminal, such as using the Real Time Streaming Protocol (RTSP) IETF RFC 2326 and/or RFC 3550, through the exemplary wireless communication link with the cellular base station transceiver 130 and/or the WLAN router 150.

The song playback management module 246 may continue to sense the song being played by the other terminal and estimate (block 408) a current playback location within the song data file received from the song file server 120 and begin song playback (block 410) at the present playback location. The current playback location within the song data may be identified by locating a match between a pattern of the song currently sensed by the microphone 220 and a pattern of the song in the song data. The module 246 can then begin playing the song starting at a location defined relative to the identified location in the song data file. The initial playback location may be offset from the location of the matched patterns to compensate for estimated processing delays.

When the song data is being streamed to the terminal, the song file server 120 may start the streaming from a playback location that is defined relative to a location corresponding to where the song identification module 244 determines that the other terminal is presently playing the song.

As described above, the song playback management module 246 may communicate with other terminals to assign to and/or received from assignment of one or more song subcomponents that are to be played therefrom. The module 246 may compare a spectral pattern of the song in the microphone signal to an expected spectral pattern defined by song data and select among the instrument tracks to play a subcomponent of the song that is indicated by the compared difference to be absent in the song played by the other terminal. The module 246 may alternatively or additionally tune an audio output filter, which filters the audio signal to the speaker 224, responsive to the compared difference to compensate for spatial attenuation of sound from the other terminal.

While the song playback management module 246 is playing a song, it may listen via the microphone 220 to the sound that is generated by other terminals, and may shift (block 412) its playback timing relative to the other terminals to, for example, become more time aligned with the other terminals playing the song and/or to otherwise vary the timing offset to provide defined spatial separation effects, such as concert hall effects that can be regulated by controlling sound phase differences relative to the other terminals. The module 246 may determine its relative playback timing by identifying a location within the song data that matches a pattern of the sensed song, and may shift (block 412) its playback time within the song based on the identified location to compensate for sound delay due to spatial separation from the other terminal.

The module 246 may additionally or alternatively respond (block 414) to sound from other terminals present in the microphone signal by changing the song subcomponent(s) that it is playing and/or by tuning an equalizer filter that is applied to the output audio signal to compensate for song subcomponents and/or frequency/amplitude characteristics that appears to be missing due to, for example, song subcomponents that do not appear to be played by the other terminals and/or due to spatial attenuation of sound from the other terminals. The module 246 may briefly stop playing music while it listens to the sound from the other terminals.

In some other embodiments, one of the terminals that is playing a song may broadcast to other adjacent terminals information that identifies the song it is playing, a current playback time within that song, and/or infonnation that permits the other terminals to synchronize their playback clocks to that of the broadcasting terminal. Instead of actively broadcasting this song and timing information, the other terminals may query the playing terminal to obtain that information. The other terminals may then choose to play or not play that song, where the decision may be responsive to whether or not those terminals contain a data file for the identified song and/or obtaining user authorization.

It is to be understood that although the exemplary system has been illustrated in FIGS. 1 and 2 with various separately defined elements for ease of illustration and discussion, the invention is not limited thereto. Instead, various functionality described herein in separate functional elements may be combined within a single functional element and, vice versa, functionally described herein in single functional elements can be carried out by a plurality of separate functional elements.

As will be appreciated by one of skill in the art, the present invention may be embodied as apparatus (terminals, servers, systems), methods, and computer program products. Accordingly, the present invention may take the form of an entirely hardware embodiment, a software embodiment or an embodiment combining software and hardware aspects all generally referred to herein as a “circuit” or “module.” It will be understood that each block of the flowchart illustrations and/or block diagrams, and combinations of blocks in the flowchart illustrations and/or block diagrams, described herein can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions can be recorded on a computer-readable storage medium, such as on hard disks, CD-ROMs, optical storage devices, or integrated circuit memory devices. These computer program instructions on the computer-readable storage medium direct a computer or other programmable data processing apparatus to function in a particular manner, such that the instructions stored in the computer-readable storage medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A wireless mobile terminal comprising:
a radio frequency (RF) transceiver that is configured to communicate via a wireless communication network with other terminals;
a speaker; and
a controller that is configured to select among a plurality of subcomponents of a song to be played from the terminal in response to communications with at least one other terminal, and to play the selected song subcomponent through the speaker.

2. The terminal of claim 1, wherein the controller is further configured to select among a plurality of instrument tracks contributing to the song to choose at least one instrument track that is to be played in response to communications with the at least one other terminal.

3. The terminal of claim 1, wherein the controller is further configured to assign at least one subcomponent of the song to the other terminal and to transmit a subcomponent assignment request to the other terminal that requests that the other terminal play the identified at least one subcomponent therefrom.

4. The terminal of claim 3, further comprising a movement sensor that generates a movement signal responsive to movement of the terminal,
wherein the controller is further configured to shuffle the assignment of subcomponents to itself and the other terminal among the song subcomponents in response to the movement signal.

5. The terminal of claim 3, further comprising a microphone that generates a microphone signal,
wherein the controller is further configured to compare a spectral pattern in the microphone signal of the song played by the other terminal to an expected spectral pattern defined by song data and to select among the instrument tracks to play a subcomponent of the song that is indicated by the compared difference to be absent in the song played by the other terminal.

6. The terminal of claim 1, wherein the controller is further configured to control a filter that filters the song played from the terminal to pass-through a frequency range corresponding to the selected song subcomponent while attenuating other frequencies of the song.

7. The terminal of claim 6, further comprising a microphone that generates a microphone signal,
wherein the controller is further configured to compare a spectral pattern in the microphone signal of the song played by the other terminal to an expected spectral pattern defined by song data and to tune the filter responsive to the compared difference to compensate for spatial attenuation of sound from the other terminal.

8. The terminal of claim 1, further comprising a microphone that generates a microphone signal,
wherein the controller is further configured to identify a location within the song of a match between a pattern of the song played by the other terminal and a known pattern of the song and to adjust its playback time within the song based on the identified location to compensate for sound delay due to spatial separation from the other terminal.

9. The terminal of claim 1, further comprising a movement sensor that generates a movement signal responsive to movement of the terminal,
wherein the controller is further configured to vary pitch of the song subcomponent that is played from the terminal in response to the movement signal.

10. The terminal of claim 1, wherein the controller is further configured to communicate with the other terminal to synchronize song playback clocks and to define a playback start time in the respective terminals.

11. The terminal of claim 10, wherein the controller is configured to synchronize the song playback clock in response to occurrence of a repetitively occurring signal of a communication network through which the terminals communicate.

12. The terminal of claim 11, wherein the transceiver communicates with the other terminal through frames of a Bluetooth wireless network and/or a WLAN, and the controller is configured to transmit a command to the other terminal that requests the other terminal to begin playing the song after occurrence of a frame access code for a defined frame of the Bluetooth wireless network and/or occurrence of a defined WLAN communication packet.

13. A wireless mobile terminal comprising:
a radio frequency (RF) transceiver that is configured to communicate via a wireless communication network with other terminals;
a speaker;
a microphone; and
a controller that is configured to identify a song present in a microphone signal from the microphone, to identify a current playback location within a song data file for the identified song, and to play the identified song starting at a location defined relative to the identified location in the song data file.

14. The terminal of claim 13, wherein the controller is further configured to record a portion of a song in the microphone signal, to transmit the recorded portion of the song as a message via the RF transceiver to an identification server along with a request for identification of the song and identification of a song file server that can supply the identified song, and to respond to a responsive message received from the identification server by establishing a communication connection via the RF transceiver to the identified song file server and requesting transmission therefrom of the song data file.

15. The terminal of claim 14, wherein the controller is further configured to identify the current playback location within the song data file received from the identified song file server in response to a match between a pattern of the song currently presently in the microphone signal and a pattern of the song in the song data file, and to initiate playing of the identified song starting at a location defined relative to the identified location in the song data file.

16. The terminal of claim 13, wherein the controller is further configured to select among a plurality of subcomponents of the song in response to communications with at least one other terminal, and is configured to play the selected song subcomponent through the speaker.

17. The terminal of claim 16, wherein the controller is further configured to control a filter that filters the song played from the terminal to pass-through a frequency range corresponding to the selected song subcomponent while attenuating other frequencies of the song.

18. The terminal of claim 17, further comprising a microphone that generates a microphone signal,
wherein the controller is further configured to compare a spectral pattern of the song in the microphone signal to an expected spectral pattern defined by song data and to tune the filter responsive to the compared difference to compensate for spatial attenuation of sound from the other terminal.

19. The terminal of claim 13, further comprising a microphone that generates a microphone signal,
wherein the controller is further configured to compare a spectral pattern of the song in the microphone signal to an expected spectral pattern defined by song data and to select among a plurality of instrument tracks to play a subcomponent of the song that is indicated by the compared difference to be absent in the song played by the other terminal.

20. The terminal of claim 13, further comprising a movement sensor that generates a movement signal,
wherein the controller is further configured to vary pitch of the song subcomponent that is played from the terminal in response to the movement signal.

21. The terminal of claim 13, wherein the controller is further configured to communicate with another terminal via the RF transceiver to synchronize song playback clocks in the respective terminals, and to tune a current playback location of the song from the song data file in response to the synchronized song playback clock.
